(19) United States
(12) Patent Application Publication
(10) Pub. No.: US 2003/0069841 A1
(43) Pub. Date: Apr. 10, 2003

(54) Methods and systems for processing financial instruments

(75) Inventor: Mark Thompson, Denver, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO

(21) Appl. No.: 09/971,726

(22) Filed: Oct. 4, 2001

(51) Int. Cl. G06F 17/60

(52) U.S. Cl. 705/39

(57) ABSTRACT

A financial instrument is processed by generating an image of the financial instrument at a point of sale as part of a transaction. An electronic package that defines the imaged instrument is transmitted through a chain of entities as part of its processing, with each entity crediting the previous entity with funds in accordance with the terms of the instrument.

### BACKGROUND OF THE INVENTION

The invention relates generally to financial systems and relates more particularly to methods and systems for processing financial instruments within financial systems.

Modern systems of commerce rely heavily on the ability of individuals and organizations to negotiate transactions with instruments rather than requiring that all transactions use cash. Traditionally, the use of instruments within financial systems has proceeded entirely with tangible instruments, which may have been passed to multiple entities as they were negotiated. The use of tangible instruments, particularly in the usual case where they are made of paper, runs the risk that the instruments will become damaged and deteriorate as a result of handling. This results in processing delays as the instruments are conveyed among parties and potentially in accidental destruction of the instrument.

The results of such processing delays may be manifested in different parts of a financial system. For example, for each institution or individual involved in clearing an instrument, delays generally add to the risks associated with its acceptance. An increase in the time it takes to present the item and find out whether it is good or bad translates directly into a greater risk that an institution or individual accepting the instrument will be left with a bad instrument.

Such processing delays may also be manifested more generally in financial systems that process instruments with a clearing institution. A clearing institution provides an arrangement in which participant financial institutions exchange instruments, sometimes on a local basis such as according to a specific metropolitan area. Some financial systems use a reserve system, such as exemplified in the United States with the U.S. Federal Reserve Banking System, structured so that financial institutions set aside reserves held against customer deposits. Such reserves are held in reserve accounts by institutions within the reserve system. When an instrument is processed through a reserve institution, the reserve account for the financial institution presenting the instrument is credited, and in this way the reserve institution also functions as a clearing institution.

Delays in processing through clearing institutions, including through reserve institutions, result in “float,” in which both the presenter financial institution and the drawee financial institution credit their books with the same funds. Significant causes of float result directly from delays caused by the use of paper negotiable instruments that require physical transfer as part of their processing. Transportation delays can result from inclement weather, airline mechanical failures, and air-traffic delays, as well as differences in holiday observances in different geographical locations, among other reasons. Moreover, instruments received by the clearing institution in poor physical condition cannot be processed on highspeed equipment otherwise used for instruments in good condition, and must sometimes be processed by hand. Computer malfunctions, unusually large volumes of instruments, and machinery breakdowns can also cause delays and contribute to float.

As a result of these concerns, some efforts have been made to use all-electronic systems, such as all-electronic checking systems. Such systems have their own deficiencies, however, because paper instruments are convenient, particularly when presented for transactions at a point of sale. There is accordingly a general need in the art for methods and systems for processing negotiable instruments that avoid such deficiencies.

### BRIEF SUMMARY OF THE INVENTION

Embodiments of the invention thus use a combination that permits a transaction to be completed at a point of sale using a tangible financial instrument, such as a paper check, but use electronic communications for subsequent processing. In certain embodiments, at the point of sale, a device is used during execution of a transaction for scanning the instrument and generating an image. In other embodiments, the image may be generated from the tangible instrument at different points in the process. The image is rendered electronically using an imaging format so that the image may be communicated electronically. For security reasons, the image may be encrypted. The original tangible instrument is destroyed or rendered void when it is imaged so that only the image is subsequently used as an effective instrument; a voided instrument may be altered to act as a receipt.

An electronic package that defines the imaged financial instrument is transmitted electronically among various institutions as it is processed to recover funds, such funds ultimately being recovered from a drawee identified on the instrument. The electronic package may comprise the image or may comprise a reference to a depository location where the image is stored. In one embodiment, the electronic package is transmitted to a first financial institution that provisionally credits the point-of-sale operator or merchant. Such crediting may be through a depository account held at the first financial institution. From there, the electronic package is transmitted directly to the drawee or may be transmitted to the drawee through a clearing institution. From the perspective of each of the institutions, a similar process is performed: the image that was originally generated at the point of sale is received and funds are credited to the previous entity in the chain in accordance with the terms on the imaged instrument. At each point in the chain, a record copy of the image may be retained and the image may be printed or otherwise converted to physical form as part of the processing. The chain generally ends at the drawee, who ultimately determines whether to honor the terms of the instrument.

The methods of the present invention as manifested at each point in the chain after the point of sale may be embodied in a computer-readable storage medium having a computer-readable program embodied therein for directing operation of a computer system. Such a computer system may include a communications system, a processor, and a storage device. The computer-readable program includes instructions for operating the computer system to process the financial instrument in accordance with the embodiments described above.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 is a schematic illustration of part of a financial system that uses a reserve system for processing financial instruments;

FIG. 2A is a schematic illustration of a first system for processing financial instruments in accordance with an embodiment of the invention;

FIG. 2B is a schematic illustration of a second system for processing financial instruments in accordance with an embodiment of the invention;

FIG. 2C is a schematic illustration of a third system for processing financial instruments in accordance with an embodiment of the invention;

FIG. 3 is a schematic illustration of the structure of a point-of-sale device that may be used with embodiments of the invention;

FIG. 4 is a schematic illustration of a configuration of a computer system on which methods of the invention may be embodied; and

FIG. 5 is a flow diagram illustrating embodiments of the invention.

### DETAILED DESCRIPTION OF THE INVENTION

Embodiments of the invention provide methods and systems for processing financial instruments. As used herein, the term “financial instrument” is intended to refer to any instrument used at a point of sale as part of a transaction. Examples of financial instruments contemplated by embodiments of the invention specifically include negotiable instruments and credit-card sales slips, each of which may include a signature of a customer at a point of sale. As used herein, “negotiable instrument” is intended to refer to any financial instrument that also meets the requirements of §3-104 of the American Law Institute's Uniform Commercial Code, specifically including a note, a draft, a check, a money order, a cashier's check, a teller's check, and a traveler's check. The customer who signs the instrument, including a credit-card sales slip, is sometimes referred to herein as the “drawer” and the institution on which the instrument is drawn, the card issuer in the case of a credit-card sales slip, is sometimes referred to herein as the “drawee.”

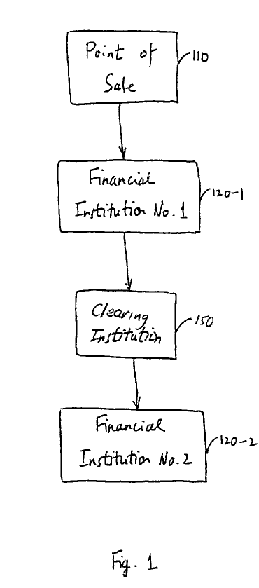

As described in detail below, certain embodiments of the invention contemplate that the processing of the financial instrument will be through a clearing institution, although other embodiments contemplate processing through only the relevant financial institutions. As used herein, the term “clearing institution” is intended to refer to arrangement for clearing financial instruments from a plurality of financial institutions, explicitly including a reserve institution such as exemplified by the reserve banks of the U.S. Federal Reserve System. An overview of how financial instruments are processed with a clearing institution is provided in FIG. 1. The financial instrument is presented to a party at a point of sale 110, typically in consideration for goods and/or services provided by the party. The financial instrument is then presented for deposit at the party's financial institution 120-1, which may be a bank, credit union, or other financial institution. When the party's financial institution 120-1 receives the financial instrument, it credits the party's deposit account on a provisional basis and seeks collection of the funds from a second (“drawee”) financial institution 120-2 on which the instrument is drawn.

In addition to the relatively simple arrangement shown in FIG. 1, the processing of a financial instrument may proceed through one or more additional intermediary financial institutions. For example, instead of receiving instruments directly from the point of sale, the first financial institution may receive a particular instrument from a third financial institution that itself received it from the point of sale (or even from yet another intermediary financial institution). The use of intermediary institutions may be of use, for example, in international transactions where the point of sale 110 is located in a first country and the drawee financial institution 120-2 is located in a second country. The instrument may be conveyed first from the point of sale 110 to a (third) financial institution in the same country as the point of sale 110. That institution may then convey all instruments it collects and which are drawn on financial institutions in the second country to the first financial institution 120-1, also located in that second country.

In those embodiments that use a clearinghouse system, the party's financial institution 120-1 sends all financial instruments it receives from any party to the clearing institution 150. This avoids a potentially costly sorting process that would be required by the financial institution 120-1 to send individual instruments to the appropriate drawee institutions. When the clearing institution receives instruments for a particular financial institution, it credits that institution for the amount of the instruments according to an availability schedule that attempts to account for normal processing times. After sorting all of the instruments that the clearing institution 150 receives, it sends all instruments in which the second financial institution 120-2 is a drawee to the second financial institution 120-2 to recover the funds it credited.

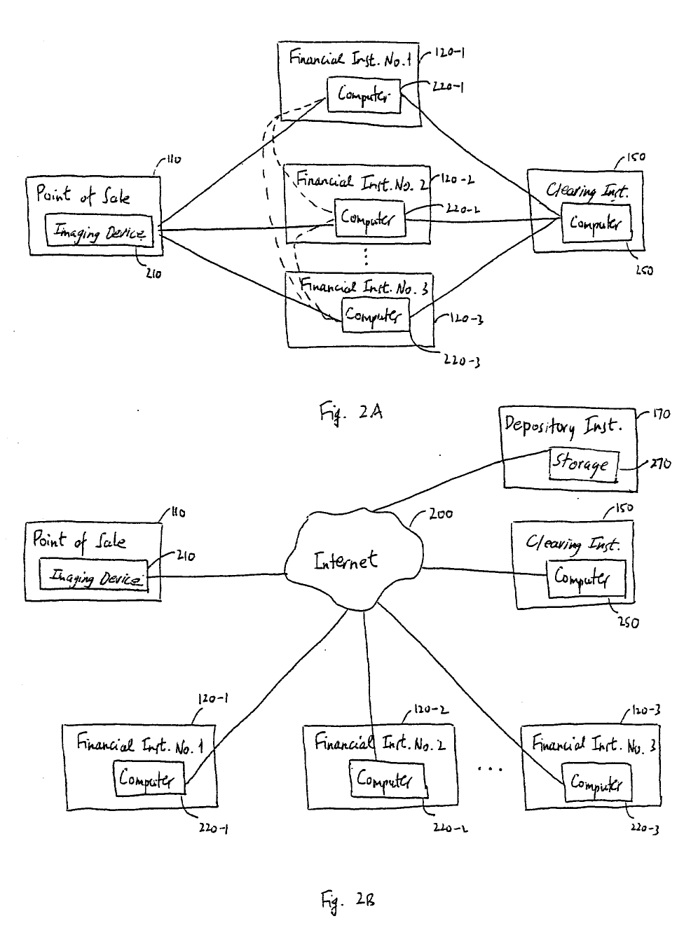

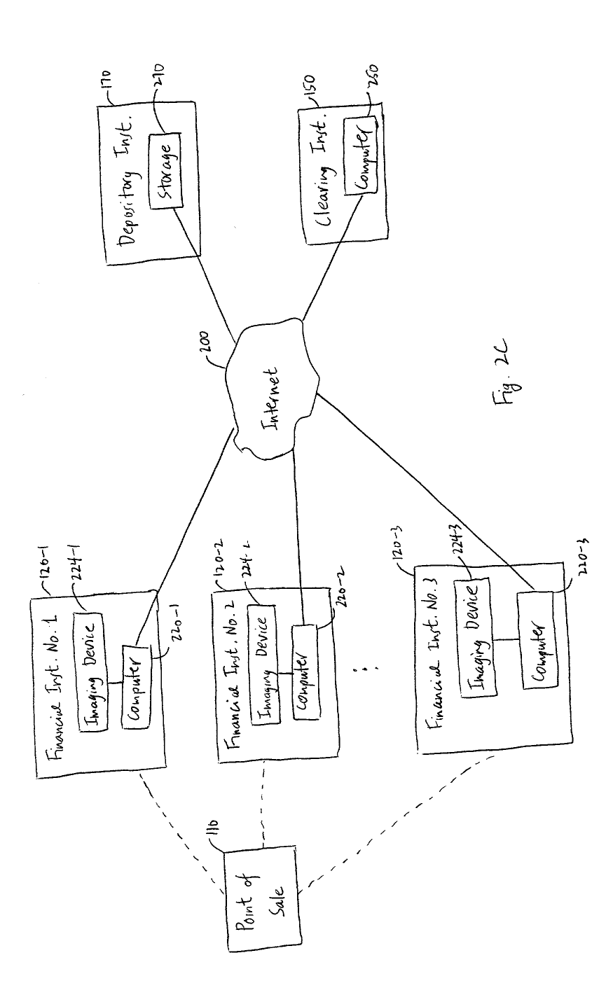

According to embodiments of the invention, an image is taken of the financial instrument, sometimes at the point of sale, with either the image or an electronic reference to a depository storage of the image being conveyed electronically throughout this process. The image is taken to be a substitute for the tangible instrument, which will typically be destroyed or voided when imaged so that the only effective instrument thereafter is the image. FIGS. 2A-2C provide examples of systems that may thus incorporate the communication of the image or electronic reference as part of the processing of the financial instrument.

FIG. 2A illustrates an embodiment in which electronic communications lines are provided between an imaging device 210 at the point of sale 110 and computer systems 220 maintained by each of a plurality of financial institutions 120 who participate in the system. In addition, similar electronic communications lines are provided between the financial institution computers 220 and a computer 250 at a clearing institution 150. The communications lines are shown in the schematic illustration as solid lines. Such an arrangement permits transmission of an electronic package including the imaged financial instrument between the necessary entities as it is processed according to embodiments of the invention. The same communications lines may be used (in the opposite direction) in some embodiments for electronic funds transfers to satisfy the terms of the financial instruments. Since the financial instruments are received electronically as images by the clearing institution 150, software may be adapted as described below to improve sorting of the instruments before they are transmitted to the respective drawee financial institutions.

The dashed lines in FIG. 2A are used to indicate that in alternative embodiments there may be electronic communications lines between the computers 220 of the different financial institutions 120. In one embodiment such supplementary communications lines are used to bypass the clearing institution 150 so that the electronic package including the imaged financial instrument is transferred directly between financial institution computers 220. Software similar to that used by the clearing institution 150 may be provided on the computer system 220 of each financial institution 120 so that sorting of imaged financial instruments for transmission to respective drawee financial institutions is simplified. Accordingly, embodiments in which communications of imaged instruments are made directly between financial institutions are more readily practical than with tangible financial instruments.

The embodiment illustrated in FIG. 2B also permits efficiencies as a result of using imaged financial instruments from the point of sale 110. In this embodiment, electronic communications lines are provided to connect the imaging device 210 at the point of sale 110, the computer 250 at the clearing institution 150, and the computers 220 at the plurality of financial institutions 120 to the Internet 200. Transmission of the imaged financial instrument among the point of sale 110, financial institutions 120, and clearing institution 150 proceeds similarly as in FIG. 2A, except that all such transmissions take place through the Internet 200. In other embodiments, a combination of networked and dedicated communications lines may be used.

It will be appreciated that with the configurations shown in both FIG. 2A and in FIG. 2B that the electronic nature of the imaged financial instrument makes it possible for a copy of it to be retained at every point within the system where it is transmitted. This has the advantage of greatly facilitating record keeping for all parties. At the same time, there is a possibility of interception, particularly where transmissions flow through the Internet 200, so that provision will generally be made for encryption of the images at every point of transmission and for corresponding decryption of the images at every point of reception.

An alternative to retaining a copy of the imaged financial instrument with each institution is to use a central depository institution 170. The role of such a depository institution 170 is not shown explicitly in FIG. 2A, although it may be included in an alternative embodiment. Because the networked arrangements illustrated in FIGS. 2B and 2C are convenient for including the functions of the depository institution, those functions are described in connection with those figures; similar functions may be included, however, with direct communications lines as shown in FIG. 2A.

Thus, in FIG. 2B, an electronic storage facility 270 maintained by the depository institution is connected with the Internet 200. After the financial instrument is imaged at the point of sale 110, the image is deposited in the storage facility 270; the depository institution may maintain software to identify the location of the deposited image and generate a code for accessing the image. Rather than transfer an electronic package that includes the actual image among financial institutions 120 and a clearing institution 150 as part of the processing, then, the electronic package instead includes the reference code. This permits any of the financial institutions 120 or clearing institution 150 involved with processing the instrument to access the instrument as desired to perform their respective functions. Such an arrangement significant reduces the storage space that might be maintained by individual institutions if they retained their own copy of each instrument. In one embodiment, the reference code is communicated to the drawer of the instrument, permitting the drawer to access images of instruments he has executed from the depository institution 170. The depository institution 170 may itself be one of a plurality of depository institutions, which may for example be distributed regionally for convenience.

The embodiment illustrated in FIG. 2C is similar to that in FIG. 2B except that there is no direct connection with the Internet 200 from the point of sale 110. Instead, tangible instruments are initially transferred, as indicated by dashed lines, from the point of sale 110 to one of the financial institutions 120. Imaging of the instrument is then performed by the financial institution using a locally available imaging device 224 in communication with that institution's computer system 220. The imaged instrument is subsequently processed in a manner similar to that described with respect to FIG. 2B. An electronic packaging including either the image or a reference code to a deposited image is conveyed through the Internet 200 among the financial institutions 120 and perhaps also through the clearing institution.

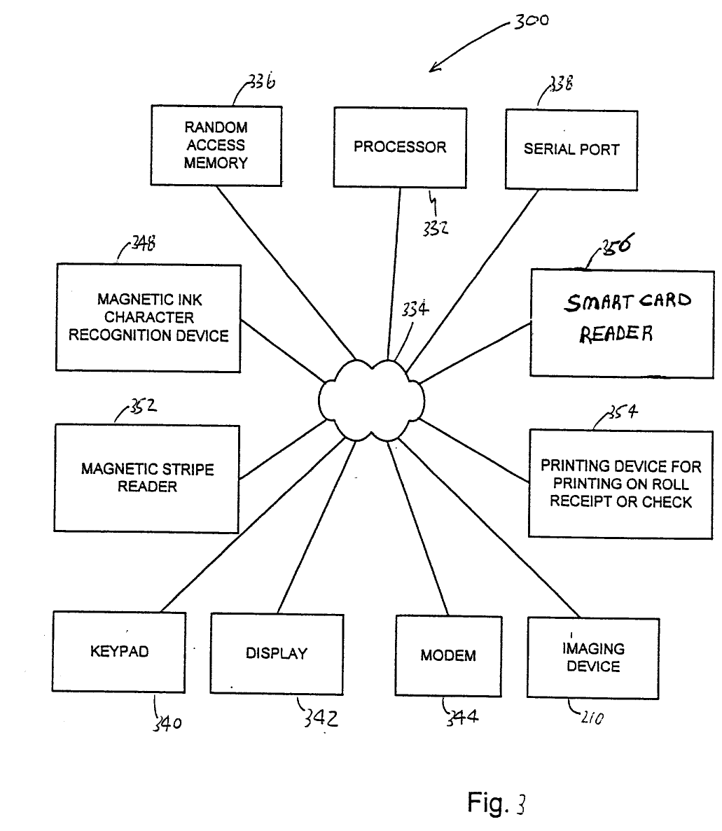

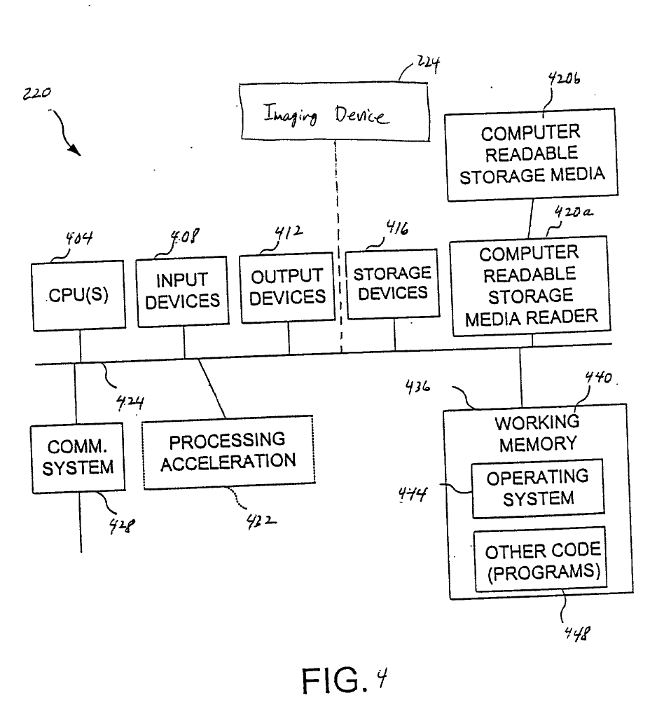

The structure of a point of sale device used in some of the embodiments to provide an initial image of the financial instrument may be better understood with reference to FIG. 3. In that figure, a schematic illustration is provided of aspects of a point-of-sale device such as described in copending commonly assigned U.S. patent application Ser. No. 09/634,901, entitled “POINT OF SALE PAYMENT SYSTEM,” filed Aug. 9, 2000 by Randy J. Templeton et al., which is a nonprovisional of U.S. Provisional Application Ser. No. 60/147,899, entitled “INTEGRATED POINT OF SALE DEVICE,” filed Aug. 9, 1999 by Randy Templeton et al., the entire disclosures of both of which are herein incorporated by reference for all purposes. A processor 332 and memory 336 are provided to manage software that implements aspects of the invention. The imaging device 210 is configured in a position to read an instrument when it is inserted within document receiving slot on the device 300 and is configured for communication with the processor 332 and memory 336 over any suitable communication path 334 (such as a data bus).

The processor 332 may also communicate over the communication path 334 with various other elements of the point-of-sale device 300. In the example illustrated, the other elements include one or more serial ports 338, a keypad 340, a display 342, and a modem 344. In addition, some embodiments include one or more of a magnetic-ink character recognition device 348, a magnetic strip reader 352 and a printing device 354, which may be adapted to print on roll receipt paper or even directly on the tangible financial instrument to act as a receipt after it has been imaged and voided. The serial ports 338 and/or modem 344 are adapted for transmission of electronic packages over the communications paths shown in FIGS. 2A-2C.

The software resident within the memory 336 and executed by the processor 332 is configured to implement those aspects of embodiments of the invention that take place at the point of sale. In particular, the software acts to operate the imaging device 210 (and perhaps also other devices shown in FIG. 3) so as to generate an image in any appropriate image format, such as a raster image format, a meta/vector image format, a graphic interchange format (“GIF”), or a joint photographic experts group (“JPEG”) format, among others. In some embodiments, the content of the image is additionally encrypted by the software for security purposes. In some embodiments, the additional elements of the point-of sale device 300 may be used to extract information that may be included with the electronic package. For example, the magnetic-ink character-recognition device 348 may be used to extract information from the financial instrument printed in magnetic ink and to format that information in the electronic package. The software may also be configured as part of a record-keeping function to retain a copy of the image or to transmit a copy of the image to the depository institution 170.

In one embodiment, the software is additionally configured to perform certain verification functions. In those embodiments where the point-of-sale device 300 is in electronic communication with the financial institutions 120 and/or the clearing institution 150, the software may be configured to access verification information from those entities as part of executing the transaction. For example, the drawee bank may embed in its paper instruments stock security features that could be read by the point-of-sale device 300, with the software configured to reject the transaction if the instrument is found to be counterfeit. In another embodiment, the software is programmed to access a signature file from the drawee institution to perform a drawer signature comparison, rejecting the transaction if the signature on the instrument fails to match the accessed signature file. Other verification checks that may be performed by the point-of-sale 300 are also within the scope of the invention. In an alternative embodiment, certain verification information is resident the memory 336 of the point-of-sale device 300 and accessed locally rather than over a communications line.

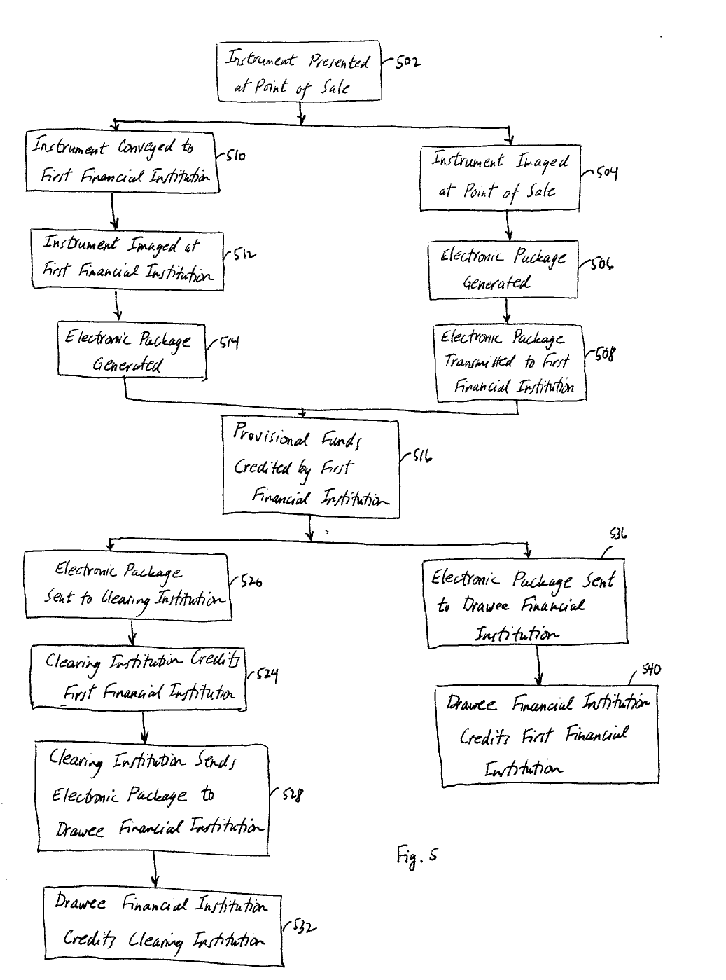

A schematic diagram of the financial institution computer systems 220 is provided in FIG. 4. This figure broadly illustrates how individual system elements may be implemented in a separated or more integrated manner. The computer system 220 is shown comprised of hardware elements that are electrically coupled via bus 424, including a processor 404, an input device 408, an output device 412, a storage device 416, a computer-readable storage media reader 420a, a communications system 428, a processing acceleration unit 432 such as a DSP or special-purpose processor, and a memory 436. The computer-readable storage media reader 420a is further connected to a computer-readable storage medium 420b, the combination comprehensively representing remote, local, fixed, and/or removable storage devices plus storage media for temporarily and/or more permanently containing computer-readable information. The communications system 428 is connected with the communications lines shown in FIGS. 2A-2C. For the embodiment shown in FIG. 2B or 2C, the communications system 428 provides a connection with the Internet 200 and may comprise a wired, wireless, modem, and/or other type of interfacing connection.

The computer system 220 also comprises software elements, shown as being currently located within working memory 440, including an operating system 444 and other code 448, such as a program designed to implement the methods and systems of the invention. It will be apparent to those skilled in the art that substantial variations may be used in accordance with specific requirements. For example, customized hardware might also be used and/or particular elements might be implemented in hardware, software (including portable software, such as applets), or both. Further, connection to other computing devices such as network input/output devices may be employed.

The software resident as part of the other code 448 is configured to perform functions for the financial institution 120. Those functions may be dependent on where the image of the financial instrument is within the overall process chain. For example, after the image is transmitted from the point of sale 110, it may be received at the first financial institution 120-1 over the communications system 428. The CPU 404 will then examine the image with the appropriate imaging format, and perhaps also decrypt the image information if it has been encrypted for security reasons. If the electronic package containing the image also includes additional information, such as may have been extracted during the original transaction by the point-of-sale device 300, that information is also decoded. Alternatively, if the image has been deposited with the depository institution 170, the reference code in the electronic package may be used to access the image from the depository institution's storage device 270 whenever necessary or desired.

A connection with the bus 424 is shown in dashed lines to show how an imaging device 224 may be included for some embodiments, such as those illustrated with FIG. 2C. In those embodiments where the initial imaging of the instrument is performed at a financial institution 120, such as shown in FIG. 2C, the software may be programmed to perform verification checks similar to those described above. For example, stock security features embedded in the drawee bank's paper instruments may be read by the point-of-sale device 300, with the transaction being rejected if the instrument is found to be counterfeit. Alternatively, a signature file from the drawee institution may be accessed to perform a drawer signature comparison, again rejecting the transaction if the signature on the instrument fails to match the accessed signature file. Other verification checks may also be performed and in alternative embodiments, certain verification information is resident on the storage device 416 and accessed locally.

Once the electronic package has been received by the first financial institution 120-1, it may be processed internally in a number of ways. In one embodiment, the image is accessed directly from the physical package or from the depository institution 170 and reduced to a physical form with the output devices 412, such as by printing a copy of it, and actions are taken with respect to it by personnel within the institution. Such actions typically include performing certain mechanical verifications regarding the instrument, such as checking dates, matching figure and written amounts, checking that the instrument has been signed, and checking endorsements in those circumstances where they are needed. Once such mechanical verifications have been performed, an account is provisionally credited with the amount of the financial instrument, with the expectation that the credited funds will be made available once the financial instrument has been accepted by the drawee institution. Such personnel will then input instructions to the software through the input devices 408 to forward the image to the drawee financial institution or to the clearing institution 150 depending on the embodiment. The software may automatically copy a record copy of the image on a storage device 416.

In an alternative embodiment, the software is configured to perform such functions. For example, the mechanical verifications may be performed by using suitable character recognition techniques to extract the necessary information from the instrument. If characters cannot be adequately recognized within predetermined confidence parameters, the software may be configured to flag such instruments for human inspection. If the recognition is adequate within the required confidence parameters, however, the software will automatically provisionally credit an account with the amount of the financial instrument and forward the image to the drawee financial institution or to the clearing institution 150 depending on the embodiment. In addition, the software may save a record copy of the image on a storage device 416.

In embodiments where the electronic package is to be forwarded directly from the first financial institution 120-1 to the drawee financial institution 102-2, the identification of the drawee institution 120-2 will generally be included as part of the electronic package. That information will have been extracted from the magnetic-ink encoding that contains a routing number for the drawee institution, such as with the magnetic-ink characterrecognition device 348 that may be comprised by the point-of-sale device 300. Alternatively, the drawee institution could be identified directly from the image, either by human analysis of the images or with character-recognition techniques. Human intervention may still be requested by the software when the software is unable to identify the drawee institution (either from decoded magnetic ink information or from character recognition techniques) within predetermined confidence levels.

Once the electronic package has been received by the drawee financial institution 120-2, the software may perform other functions appropriate for that point of the process chain. In one embodiment, the image is again reduced to a physical form with the output devices 412, such as by printing a copy of it, and actions are taken with respect to it by personnel within the drawee institution. Such actions will generally be similar to those performed by the first financial institution 120-1, in which mechanical verifications are performed regarding the instrument, and in which an account is credited should the imaged instrument be found acceptable. At this stage of the process, the credited account will be either an account for the first financial institution 120-1 or an account for the clearing institution 150, depending on the embodiment. In alternative embodiments, the software uses character recognition techniques to perform those functions, perhaps identifying specific images for human analysis when necessary as described above. A record copy of the image may be retained on a storage device 416.

The computer system 250 of the clearing institution 150 may be configured similarly to the computer systems 220 of the financial institutions 120 since similar functions are performed. The images received from various financial institutions 120 are verified so that appropriate accounts for those financial institutions are credited, and the images are sorted so that they may be transmitted to the appropriate drawee institutions. Such functions are generally performed automatically by software, with human intervention only when the transmitted images cannot adequately be analyzed by the software. As for the processing performed for the financial institutions, the clearing institution 150 may retain a record copy of the image.

If the image is rejected at any time in the processing of the imaged financial instrument along the chain point-of-sale→first financial institution→[clearing institution]→drawee financial institution, that fact is back propagated through the system. For example, if the drawee financial institution determines that the drawer of the instrument has insufficient funds on account, it may dishonor the instrument. Notification of such dishonor is back propagated using the electronic communications lines shown in FIGS. 2A-2C. Once the first financial institution is notified of such dishonor any funds that were provisionally credited to an account are withdrawn.

Various embodiments of the invention as described above are summarized with the flow diagram in FIG. 5. At block 502, the financial instrument is presented as part of a transaction. After such presentment, the financial instrument may be imaged at the point of sale at block 504 on the right side of the figure. An electronic package that defines the image, either by including the image or including a database reference code to the image, is generated from the scanning at block 506. The electronic package is thus transmitted to the first financial institution 120-1 at block 508. Alternatively, the tangible instrument may instead be conveyed physically to the first financial institution 120-1 at block 510 on the left side of the figure. In that case, the instrument is imaged at the first financial institution 120-1 at block 512, with the electronic package defining the image being generated at block 514. After either block 508 or block 514 the first financial institution has the electronic package that defines the imaged instrument and it therefore credits provisional funds at block 516.

At this stage, different embodiments correspond to use of a clearing institution 150 in the processing, shown in the left portion of the figure, and direct interaction between financial institutions, shown in the right portion of the figure. Thus, in embodiments that use a clearing institution 150, the electronic package is transmitted to the clearing institution 150 at block 520. The clearing institution 150 then credits the first financial institution at block 524. After identifying the drawee financial institution, the clearing institution 150 transmits the electronic package to the drawee institution at block 528. The drawee financial institution, after examining the imaged instrument, credits the clearing institution at block 532.

In embodiments that do not use the clearing institution 150, a similar process is followed. At block 536, the electronic package is transmitted from the first financial institution to the drawee financial institution after that institution has been identified. The drawee financial institution, after examining the imaged instrument, then credits the first financial institution at block 540.

Having described several embodiments, it will be recognized by those of skill in the art that various modifications, alternative constructions, and equivalents may be used without departing from the spirit of the invention. For example, while the invention has been described with the imaged financial instrument being transmitted directly to a financial institution, it will be understood that it may more generally be negotiated further before it is processed by the financial system. Accordingly, the above description should not be taken as limiting the scope of the invention, which is defined in the following claims.

What is claimed is:

1. A method for processing a financial instrument, the method comprising:
receiving an electronic package defining an image of the financial instrument at a first institution from a presenter, the image having been generated as part of a transaction at a point of sale; and
crediting the presenter for funds in accordance with the financial instrument.

2. The method recited in claim 1 wherein the electronic package comprises the image.

3. The method recited in claim 1 wherein the image is stored at a location within a depository and the electronic package comprises a reference to the location.

4. The method recited in claim 1 wherein the first institution comprises a financial institution.

5. The method recited in claim 4 wherein the first institution comprises a bank.

6. The method recited in claim 1 further comprising transmitting the electronic package to a second institution for recovery of the funds.

7. The method recited in claim 6 wherein the second institution comprises a clearing institution.

8. The method recited in claim 7 wherein the clearing institution comprises a reserve institution.

9. The method recited in claim 6 wherein the second institution comprises a drawee financial institution, the method further comprising identifying the drawee financial institution from the electronic package.

10. The method recited in claim 9 wherein the first institution comprises a clearing institution.

11. The method recited in claim 6 wherein crediting the presenter comprises provisionally crediting an account of the presenter, the method further comprising releasing the credited funds after recovery of the funds.

12. The method recited in claim 1 wherein the first institution comprises a drawee financial institution identified by the financial instrument.

13. The method recited in claim 12 wherein the presenter comprises a clearing institution.

14. The method recited in claim 1 wherein the image is encrypted, the method further comprising decrypting the image.

15. The method recited in claim 1 wherein the financial instrument comprises a check.

16. The method recited in claim 1 wherein the financial instrument comprises a credit-card sales slip.

17. A method for processing a financial instrument, the method comprising:
generating an image of the financial instrument as part of a transaction at a point of sale; and
transmitting an electronic package defining the image of the financial instrument to an institution for recovery of funds in accordance with the financial instrument.

18. The method recited in claim 17 further comprising transmitting the image to a depository for storage.

19. The method recited in claim 17 wherein the electronic package comprises the image.

20. The method recited in claim 17 wherein the image is stored at a location within a depository and the electronic package comprises a reference to the location

21. The method recited in claim 17 wherein the institution comprises a financial institution.

22. The method recited in claim 21 wherein the first institution comprises a bank.

23. The method recited in claim 17 wherein the financial instrument comprises a check.

24. A method for processing a financial instrument, the method comprising:
receiving a reference to a location in a depository where an image of the financial instrument is stored; and
crediting the presenter of the reference with funds in accordance with the financial instrument.

25. The method recited in claim 24 further comprising transmitting the reference an institution for recovery of the funds.

26. The method recited in claim 25 wherein the institution comprises a financial institution.

27. The method recited in claim 25 wherein the institution comprises a clearing institution.

28. The method recited in claim 24 wherein the financial instrument comprises a check.

29. The method recited in claim 24 wherein the financial instrument comprises a credit-card sales slip.

30. A computer-readable storage medium having a computer-readable program embodied therein for directing operation of a computer system for a first institution, the computer system including a communications system, a processor, and a storage device, wherein the computer-readable program includes instructions for operating the computer system to process a financial instrument in accordance with the following:
receiving an electronic package defining an image of the financial instrument from a presenter with the communications system, the image having been generated as part of a transaction at a point of sale; and
crediting an account of the presenter for funds in accordance with the financial instrument.

31. The computer-readable storage medium recited in claim 30 wherein the computer-readable program further includes instructions for operating the computer system for transmitting the electronic package to a second institution for recovery of the funds.

32. The computer-readable storage medium recited in claim 30 wherein the image is stored at a location within a depository and the electronic package comprises a reference to the location, the computer-readable program further including instructions for retrieving the image from the location.

33. The computer-readable storage medium recited in claim 30 wherein the financial instrument comprises a check.

34. A computer system comprising:
a communications system;
a storage device;
a processor in communication with the communications system and the storage device; and
a memory coupled with the processor, the memory comprising a computer-readable storage medium having a computer-readable program embodied therein for directing operation of the computer system to process a financial instrument, the computer-readable program including:
instructions for receiving an electronic package defining an image of the financial instrument from a presenter with the communications system, the image having been generated as part of a transaction at a point of sale; and
instructions for crediting the presenter for funds in accordance with the financial instrument.

35. The computer system recited in claim 34 wherein the computer-readable program further includes instructions for transmitting the image of the financial instrument to a second institution for recovery of the funds.

36. The computer system recited in claim 34 wherein the image is stored at a location within a depository and the electronic package comprises a reference to the location, the computer-readable program further including instructions for retrieving the image from the location.

37. The computer system recited in claim 34 wherein the communications system is adapted for connection with the Internet.

38. The computer system recited in claim 34 wherein the financial instrument comprises a check.
